(19) United States
(12) Patent Application Publication
(10) Pub. No.: US 2006/0004781 A1
(43) Pub. Date: Jan. 5, 2006

(54) Upward and downward compatible schema evolution

(76) Inventors: Marcus Burgel, Heroldsberg (DE); Edgar Frank, Nurnberg (DE); Rainer Heller, Eckental (DE); Heinrich Kutzer, Nurnberg (DE); Dieter Wissmann, Pinzberg (DE)

Correspondence Address: Siemens Corporation;Intellectual Property Department, 170 Wood Avenue South, Iselin, NJ, 08830, US

(21) Appl. No.: 10/532,732

(22) PCT Filed: Oct. 17, 2003
(86) PCT No.: PCT/DE03/03453

§ 371 Date: Apr. 26, 2005

(30) Foreign Application Priority Data
Oct. 30, 2002 (DE) 10250641.8

(51) Int. Cl. G06F 7/00

(52) U.S. Cl. 707/100

(57) ABSTRACT

The invention relates to a method and a system for defining structures of object and/or data models, comprising at least one schema for describing the structures. An upward and downward compatible schema evolution is achieved in that a labeling of a version of the corresponding schema is carried out in a first attribute of a schema wherein the namespace used in the corresponding schema and the type and element name used in the corresponding schema are preserved regardless of the version, wherein the types and elements are expanded only while preserving the type or element name. Unexpanded types and elements are accepted in the schemas of a newer version unchanged from the types or elements of schemas of an older version.

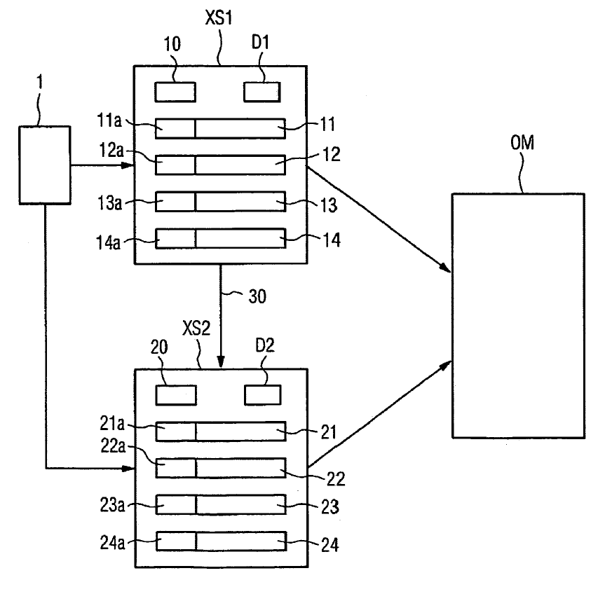

### CROSS REFERENCE TO RELATED APPLICATIONS

This application is the US National Stage of International Application No. PCT/DE2003/003453, filed Oct. 17, 2003 and claims the benefit thereof. The International Application claims the benefits of German application No. 10250641.8 filed Oct. 30, 2002, both applications are incorporated by reference herein in their entirety.

### FIELD OF THE INVENTION

The invention relates to a method as well as a system for definition of structures of object and/or data models, with at least one schema for description of the structures.

### SUMMARY OF THE INVENTION

Structures of object and data models are typically defined in software development with class/type models and schemas (e.g. database schemas, XML (=Extensible Markup Language) schemas). In the following text the term schema should also be taken to mean class/type model. Schemas are thus used for description of how data will be stored. In general the data to be stored changes in its structure over time. It is thus necessary to change the underlying schema in each case, i.e. a schema evolution takes place. The following things are of significance for this schema evolution: On the one hand it must be possible for the version of a schema to be labeled. On the other hand the compatibility between different schemata must be able to be clarified and specified. Compatibility between two schemas means here that data which is correctly stored with reference to one schema is also correct with reference to the other schemas. “Data is correct for a schema” is taken to mean that the content of the data can be correctly interpreted by an application if the meaning of structures from the schema is known to the application. The short phrase “data of a schema” will be used to refer to data which is correct in relation to a schema. With compatibility of schemas a distinction is usually made between upward compatibility (=data of an old schema is correct as regards a new schema) and downward compatibility (=data of a new schema of which the content corresponds to structures of the old schema is correct as regards an old schema). The properties of upward and downward compatibility between the schema versions are eminently important since they have direct effects on the feasibility and expense for the migration of end-user data from software products. Nowadays the W3C standard XML Schema (W3C=World Wide Web Consortium) is often used for schema implementation. There are mechanisms for schema evolution in this standard. If these mechanisms are employed in a standard way in object-oriented software development, XML schemas are obtained which are upward-compatible but which are not however downward-compatible.

The object of the invention is to make an upward and downward-compatible schema evolution possible.

This object is achieved by a method for definition of structures of object and/or data models in which schemata describe the structures, with an identification of a version of the relevant schema being produced in a first attribute of a schema, with the namespace used in the relevant schema and the type and element name used in the relevant schema being preserved regardless of the version, with types and elements only being expanded while preserving the type or element name and with unexpanded types and elements being accepted unchanged into schemata of a newer version from the types or elements used in schemata of an older version in each case.

This object is achieved by a system for definition of structures of object and/or data models with at least one schema for description of the structures, with a first attribute of a schema to label a version of the relevant schema being provided, with the name space used in the relevant schema and the type and element name used in the relevant schema being preserved regardless of the version, with a mechanism being provided for expansion of the types and elements while preserving the type or element name and for unchanged transfer of unexpanded types or elements used in schemata of an older version into schemata of a newer version.

The present invention demonstrates a way of executing a schema evolution such that the schemas are both upward and also downward-compatible. The invention makes possible a schema evolution, without changing the name of the data. The basic idea here is to preserve the name space, the type and the element names on transition to a new schema version and to use a schema version identifier. E: The name space is a collection of names which are labeled by a unique identifier. A namespace is thus something like a container for elements and attributes, which itself possesses a unique name.

The versioning of the schemas is mapped exclusively via attributes. In this case a first attribute of a schema is used to label a version of the relevant schema. In accordance with an advantageous embodiment of the invention a calendar date can be assigned via a second attribute to a version of a schema. The calendar date of the relevant schema version can for example be stored in what are known as the “annotations” for the schema, using an attribute “version date”.

If the schemata are described by an extensible markup language, e.g. XML, systematic validation capabilities are obtained in addition to uniformity and expandability.

The invention is described and explained in more detail below on the basis of the exemplary embodiment shown in the sole FIGURE.

### BRIEF DESCRIPTION OF THE DRAWING

The sole FIGURE shows a system for definition of structures of object and/or data models, with schemata for description of the structures.

### DETAILED DESCRIPTION OF THE INVENTION

Shown in the exemplary embodiment are a first schema XS1 of an older version and a second schema XS2 of a newer version, which both describe the structures of an object model OM. The arrow 30 symbolizes the schema evolution. Schemata XS1, XS2 contain types and elements 11 . . . 14, 21 . . . 24, to which type or element names 11a . . . 14a, 21a . . . 24a are assigned. A namespace 1 is assigned to the schemata XS1, XS2. In first attributes 10, 20 and second attributes D1, D2 of the schemata XS1, XS2 version identifications or calendar dates can be stored

The inventive idea is explained below with reference to the W3C Standard XML Schema often used for schema implementation. The mechanisms described however can in principle be used in the description of the structures of any object and data models, independent of standards. Upward-compatible XML schemas have been defined previously, but not downward-compatible XML schemas The definition of upward-compatible XML schemas has been achieved as follows: In XML Schema there are the mechanisms “type derivation”, target namespaces and the attribute “version” for element <xsd:schema>. If these mechanisms are used in the way known in object-oriented software development, this means that derived types are given different names from their father types. This means that data of newer XML schemas are given different names from the corresponding data of old XML schemas Both the old and also the new names of data are known to new applications via the type derivation relationship. They can therefore interpret old and new data. The XML schemas are thus upward-compatible. However since names of data have changed, old applications, to which the new names cannot be known, cannot interpret new data. The schemas are not downward-compatible. It is then only possibly to use cross-version XML documents by using a converter which converts the XML documents into the correct version in each case. However this has the major disadvantage that nothing can be done with new data alone. An appropriate converter is then always needed.

For the transition from one XML schema version to the next, XML Schema makes various means available. To enable element definitions to be expanded without changing the name of an element, XML Schema provides the means of redefinition of element types. The idea of a redefinition is to undertake an “inheritance” without changing the name of the element type. The mechanism of the redefinition also includes the transfer of non-redefined types from the old schema definition. I.e. through the use of the redefinition an “Include-mechanism” to transfer the old types is simultaneously initiated. This also supports an upward-compatible further development of a schema. The implementation of the transition from one XML schema version to the next is described below with reference to a schematic example. The XML Schema versions, the associated namespaces and the type definitions in the relevant XML schema are to be considered here. The versioning of the schemas will be mapped exclusively via attributes. In this case the attribute “version” of the element “xsd:schema” of XML Schema is used. In addition the date of the schema version can be stored in the “annotations” for the schema via an attribute “version date”.

The types “Project”, “HW”, “Comm” are only used by way of example and stand for any types. All three types are present in both Version 1.0 and also in Version 2.0. The types “HW” and “Comm” remain unchanged. The type “Project” is changed via redefinition in Version 2.0. In addition the new type Monitoring is defined in Version 2.0. No new namespace was introduced for a new schema version. In addition the local names of the types were preserved. Thus the names of the types already present in Version 1.0 have not changed overall. The correct data for a new schema for which the content corresponds to structures of the old schemas, is also correct with regard to the old schemas. The schema evolution is downward-compatible. Since the new schema has been produced by “derivation” from the old schema, the schema evolution is also upward-compatible. This means that the schema evolution is upward and downward—compatible. In addition the “validatability” of the W3C applies in the original sense, that the old and the new data (XML documents) are valid as regards the new schema. The versioning concept of the XML Schema Standard and of the redefinition mechanism of XML Schema will also be used to achieve the upward and downward-compatibility of data for the schema evolution. It should be stressed that the definition of the expression “data (and thereby XML documents) are correct” used here as regards an XML schema differs from the definition of W3C: “data (XML documents) are valid as regards an XML schema”. Whereas the definition of W3C is purely syntactical in nature, i.e. relates to the structure of an XML document, the definition used here is determined by the semantic content and the interpretability of the data.

The above schematic example appears as follows in XML and XML Schema syntax:

XML Entity Document for Schema Version 1.0

<?xml version=“1.0” encoding=“UTF-8”?>
<Document xmlns=“Namespace1” xmlns:xsi=“http://www.w3.org/2001/XMLSchema-instance”
xsi:schemaLocation=“Namespace1 D1.xsd”>

<Project>

<HW/>

</Project>
<Project>

<HW/>

</Project>

</Document>

XML Schema for Version 1.0: File D1.xsd

<?xml version=“1.0” encoding= “UTF-8”?>
<xs:schema targetNamespace=“Namespace1” xmlns:ns1=“Namespace1”
xmlns:xs=“http://www.w3.org/2001/XMLSchema” elementFormDefault=“qualified”
attributeFormDefault= “unqualified” version=“1.0”>
<xs:annotation>

<xs:documentation>This schema is the first version of this schema

type</xs:documentation>

<xs:appinfo>

<prim:schemainfo versiondate=“20011206” />

</xs:appinfo>

</xs:annotation>

<xs:elements Name=“Document” type= “ns1:DocumentT”>

<xs:annotation>

<xs:documentation>Comment describing your root elements</xs:documentation>

</xs:annotation>

</xs:elements>
<xs:complexType Name=“DocumentT”>

<xs:sequence>

<xs:elements ref=“ns1:Project” maxOccurs=“unbounded”/>

</xs:sequence>

</xs:complexType>
<xs:elements Name=“Project” type=“ns1:ProjectT”/>
<xs:complexType Name=“ProjectT”>

<xs:sequence>

<xs:elements ref=“ns1:HW”/>

</xs:sequence>

</xs:complexType>

<xs:elements Name=“HW” type=“ns1:HWT”/>

<xs:complexType Name=“HWT”/>
<xs element name=“Comm” type“ns1:CommT”/>
<xs:complexType Name= “CommT”/>
</xs:schema>

XML Entity Document for Schema Version 2.0

<?xml version=“1.0” encoding= “UTF-8 ”?>
<Document xmlns=“Namespace1” xmlns:xsi=“http://www.w3.org/2001/XMLSchema-instance”
xsi: schemaLocation=“Namespace 1
D2.xsd”>

| | |
|---|---|
| <Project> | <!-- Elementtype redefined in Schema version 2.0 --> |

| | |
|---|---|
| <HW/> | <!-- Element already existing as subelement of Project in Schema |

version 1.0 -->

| | |
|---|---|
| <Comm/> | <!-- Reuse of Element defined in Schema version 1.0 --> |

<Monitoring/> <!-- Element newly defined in Schema version 2.0 -->

</Project>
<Project>

<HW/>
<Comm/>
<Monitoring/>

</Project>

</Document>

XML Schema for Version 2.0: File D2.xsd

<?xml version=“1.0” encoding= “UTF-8”?>
<xs:schema targetNamespace=“Namespace1” xmlns=“Namespace1”
xmlns:xs=“http://www.w3.org/2001/XMLSchema” elementFormDefault=“qualified”
attributeFormDefault=“unqualified” version=“2.0”>
<xs:annotation>

<xs:documentation>This schema enhances the previous schema

version/xs:documentation>

<xs:appinfo>

<prim:schemainfo versiondate=“20011218” />

</xs:appinfo>

</xs:annotation>

<xs:redefine schemaLocation=“D1.xsd”>

<xs:complexType Name=“ProjectT”>

<xs:complexContent>

<xs:extension base=“ProjectT”>

<xs:sequence>

<xs:elements ref=“Comm”/>
<xs:elements ref=“Monitoring”/>

</xs:sequence>

</xs:extension>

</xs:complexContent>

</xs:complexType>

</xs:redefine>
<xs:elements Name=“Monitoring” type=“MonitoringT”/>
<xs:complexType Name=“MonitoringT”/>

</xs:schema>

In summary the invention relates both to a method and to a system for definition of structures of object and/or data models OM, with at least one schema XS1, XS2 for description of the structures. An upward and downward-compatible schema evolution is achieved by, in a first attribute 10, 20 of a schema XS1, XS2, a version of the relevant schema. XS1, XS2 being labeled, with the namespace 1 used in the relevant schema XS1, XS2 and the type and element names 11a . . . 14a, 21a . . . 24a used in the relevant schema XS1, XS2 being preserved regardless of the version, with types and elements 11 . . . 14, 21 . . . 24 only being expanded while preserving the type or element name 11a . . . 14a, 21a . . . 24a and with unexpanded types and elements 21 . . . 24 in schemata XS2 of a newer version being accepted automatically unchanged from the types or elements 11 . . . 14 used in a relevant schemata XS1 of an older version.

1-6. (canceled)

7. A method for defining structures of object and/or data models, wherein schemata describe the structures, each schema having a namespace, type names, and element names, the method comprising:
characterizing a schema by assigning a version of the schema to a first attribute of the schema, wherein
the namespace, type names, and element names of the schema are maintained independently of the version, wherein
types and elements are expanded maintaining the respective type names or element names, and wherein
unexpanded types and elements are accepted unchanged into schemata characterized by a newer version from types and elements used in schemata characterized by an older version.

8. The method according to claim 7, wherein a calendar date can be assigned via a second attribute to a version of the schema.

9. The method according to claim 7, wherein the schemata are described by an extensible markup language.

10. The method according to claim 8, wherein the schemata are described by an extensible markup language.

11. A system for definition of structures of object models and/or data models having at least one schema for description of the structures, wherein
a first attribute of a schema is provided for identification of a version of a relevant schema, wherein
a namespace used in the schema and type names and element names used in the schema are preserved regardless of the version, the system comprising:
a mechanism for expansion of the types and elements while preserving the type names respectively the element names and for unchanged acceptance of unexpanded types or elements used in schemas having an older version into schemas having a newer version.

12. The system in accordance with claim 11, wherein a calendar date is assigned via a second attribute to a version of a schema.

13. The system in accordance with claim 11, wherein the schemata are described by an extensible markup language.

14. The system in accordance with claim 12, wherein the schemata are described by an extensible markup language.
